(19) United States
(12) Patent Application Publication
(10) Pub. No.: US 2006/0255727 A1
(43) Pub. Date: Nov. 16, 2006

(54) SILVER ALLOY THIN FILM REFLECTOR AND TRANSPARENT ELECTRICAL CONDUCTOR

(76) Inventor: Han Nee, Newport Coast, CA (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/461,193

(22) Filed: Jul. 31, 2006

Related U.S. Application Data
(62) Division of application No. 10/431,695, filed on May 8, 2003, now abandoned.
(60) Provisional application No. 60/378,884, filed on May 8, 2002.

(51) Int. Cl. H01J 1/62; H01J 63/04

(52) U.S. Cl. 313/506

(57) ABSTRACT

A silver-based alloy thin film is provided, suitable for use as a reflective and/or a transparent electrical conductor for various opto-electronic device applications such as liquid crystal displays, flat panel displays, plasma displays, solar cells, organic light emitting diode and electrochromic or energy efficient windows. Elements alloyed with silver include copper, palladium, platinum, gold, zinc, silicon, cadmium, tin, lithium, nickel, indium, chromium, antimony, gallium, boron, molybdenum, germanium, zirconium, beryllium, aluminum, magnesium, manganese, cobalt and titanium. Over a thickness range of 3 nm to 20 nm, these silver alloy thin films can be used as transparent electrical conductors. At a thickness greater than 20 nm, they can be used as reflectors. These alloys have moderate to high reflectivity and electrical conductivity and reasonable good corrosion resistance under ambient conditions.

### CROSS REFERENCE TO RELATED APPLICATION

This application is a divisional application of 10/431,695, filed May 8, 2003 and also claims the benefit of U.S. Provisional Application No. 60/378,884 filed May 8, 2002, both of which are herein incorporated by reference.

### FIELD OF THE INVENTION

This invention relates to a silver alloy thin film used as a transparent electrical conductor, a transparent layer or a highly reflective layer for opto-electronic device applications such as flat panel displays, liquid crystal displays, plasma displays, cathode ray tubes, organic light emitting diodes, solar cells and electrochromic or energy efficient windows, etc.

### BACKGROUND OF THE INVENTION

For use in opto-electronic devices, transparent electrical conductors form an essential class of materials in technologies that require both large area electrical conductivity and optical transparency in the visible range of the light spectrum. Currently, few types of transparent conducting oxides (TCO) dominate the market for transparent electrical conductors. The two largest markets for TCOs are architectural glass and flat panel displays (FPD). TCOs are used in architectural applications to construct energy efficient windows wherein a fluorine-doped tin oxide is deposited on a glass substrate usually by a pyrolitic process. Windows with tin oxide coatings efficiently reduce radiative heat loss due to TCO's low emissivity in the infrared region of the spectrum.

The annual consumption of TCO-coated architectural glass in the United States is about 100 million square meters, a very large market. The most widely used TCO in FPD applications has been indium tin oxide (ITO). As the volume of FPDs produced continues to grow, so does the volume of ITO coatings produced.

More recently, electronic devices for the “mobile office” devices such as personal digital assistants, mobile phones, notebook computers, and digital cameras have been proliferating. The vast majority of these devices use FPDs. The market for FPDs in the US estimated to have been about $15 billion in the year 2000 is predicted to grow to over $30 billions in 2005. As the market for FPDs continues to expand, the need to increase the performance and reduce the cost of FPDs increases. In the past few years, there has been a realization that traditionally used TCOs such as zinc oxide and indium tin oxide are not sufficient to meet the more demanding requirements of the contemporary and future device. As the screen size of FPDs increases and notebook computers are required to run ever-faster graphics, it is becoming increasingly important to decrease the resistivity of TCO layers without significantly reducing the optical transparency of these layers. The silver alloy thin films of the current invention used as stand-alone layers to replace ITO or in conjunction with ITO can effectively address this need.

Moreover, because the silver alloy thin films of the current invention are inherently far more electrically conductive than TCOs, silver alloy thin films can be a factor of 10 to 50 times thinner than a typical TCO and still perform satisfactorily in these applications. Additionally, the deposition rate for silver alloy thin films applied to surfaces by a conventional DC-magnetron sputtering process can be a factor of 10 faster than the deposition rate for TCO's applied to the same surfaces. Pure silver is highly conductive and reflective but it is generally not as corrosion resistant as ITO, therefore, one objective of the current invention is to alloy silver with various specific elements to make silver alloys that are more corrosion resistant and more useful than those taught by the prior art.

Published Japan patent applications JP-A-63-187399 and JP-A-7-114841, disclose a transparent electrode of a three-layer structure comprising a silver layer sandwiched between two ITO layers with low resistivity and improved transparency for use in a liquid crystal display. However, as the corrosion resistance of pure silver is relatively low, these inventions were not very useful. Recently U.S. Pat. Nos. 6,014,196 and 6,040,056 recited silver combined with gold, palladium or platinum. European patent application EP 0 999 536 A1, disclosed a similar transparent laminate, a silver alloy layer with added noble metal alternatively sandwiched by 3 to 5 layers of ITO. While the addition of noble metals increases the corrosion resistance of silver, it also costs substantially more to make, reducing the overall utility of these alloys. One object of the invention is to address the need for less expensive and improved transparent conductors by alloying silver with low cost alloying elements, thereby producing lower cost silver alloys with satisfactory corrosion resistance, as well as acceptable optical, and electrical properties.

U.S. Pat. No. 6,122,027 discloses a reflective type liquid crystal display device with an aluminum reflector. Since the reflectivity of silver alloys is generally higher than that of aluminum, this invention offers a functional improvement over this prior art. U.S. Pat. No. 6,081,310, discloses a silver or silver alloy layer reflector used in a reflective type liquid crystal display. However, these alloys are applied by electroplating, and this method of applying the silver alloy severely limits the choice of useful alloying elements. In one preferred embodiment of this invention, the silver alloy layer is applied by vacuum coating. This method of forming the silver alloy layer permits silver to be alloyed with a wide variety of elements to form a wide variety of silver alloys for use in a wide variety of applications.

### SUMMARY OF THE INVENTION

Silver alloy thin films, with a thickness in the range of 3 to 20 nm usable as a transparent conductor in a variety of optico-electric stacks, for use in a variety of devices. Silver is alloyed with elements in the range of about 0.1 a/o percent to about 10.0 a/o percent, such as: gold, palladium, platinum, copper, zinc, cadmium, indium, boron, silicon, zirconium, antimony, titanium, molybdenum, zirconium, beryllium, aluminum, lithium, nickel, antimony, chromium, gallium, germanium, magnesium, manganese, cobalt and tin. The silver alloy thin films of this invention transmit between 50 and 95% of the light in the visible spectrum and are also electrically conductive. Silver alloys with the same composition as those used in transparent applications, deposited by vacuum coating techniques to form layers of about 20 to about 200 nm thick, are useable as a highly reflective layer in optico-electric stacks for use in devices that interact with infrared, visible, or ultraviolet light.

### BRIEF DESCRIPTION OF THE DRAWINGS

FIG. 1 a cross sectional view of a transparent, electrically conductive stack, a transparent conductive film is attached to a transparent substrate.

FIG. 2 a cross sectional view of a transparent, electrically conductive, film stack attached to a transparent substrate wherein the transparent conductor stack contains a thin silver alloy film sandwiched by transparent conducting oxides.

FIG. 3 a cross sectional view of a transparent, electrically conductive, film stack attached to a transparent substrate wherein the transparent conductor stack contains layers of thin silver alloy films sandwiched by oxides. Depending upon the layers used this could also be a cross sectional view of an electrochromic window.

FIG. 4 a cross sectional view of a transmission type liquid crystal display. The display may, for example, use an electrically conductive film stack including a silver alloy film of the invention.

FIG. 5 a cross sectional view of a reflective type liquid crystal display. The display may, for example, use an electrically conductive film stack of this invention including a silver alloy film of the invention.

FIG. 6 a cross sectional view of elements of an organic light emitting diode using. The silver alloy thin film of this invention may, for example, function as a transparent and electrically conductive layer in the device.

FIG. 7 a cross sectional view of a solar cell. A silver alloy film of this invention may, for example, function as a transparent conductor in the solar cell.

FIG. 8 a cross sectional view of a transparent coating of organic or inorganic film on a conductive transparent or reflective layer on a substrate. The conductive transparent or reflective layer may be, for example, a silver alloy film of this invention.

### DETAILED DESCRIPTION OF THE INVENTION

Specific language is used in the following description and examples to publicly disclose the invention and to convey its principles to others. No limits on the breadth of the patent rights based simply on using specific language are intended. Also included are any alterations and modifications to the descriptions that should normally occur to one of average skill in this technology.

As used in this specification the term “atomic percent” or “a/o percent” refers to the ratio of atoms of a particular element or group of elements to the total number of atoms that are identified to be present in a particular alloy. For example, an alloy that is 15 atomic percent element “A” and 85 atomic percent element “B” could also be referenced by a formula for that particular alloy: A_{0.15}B_{0.85}.

As used herein the term “of the amount of silver present” is used to describe the amount of a particular additive that is included in the alloy. Used in this fashion, the term means that the amount of silver present, without consideration of the additive, is reduced by the amount of the additive that is present to account for the presence of the additive in a ratio. For example, if the relationship between Ag and an element “X” is Ag_{0.85} X_{0.15} (respectively 85 a/o percent and 15 a/o percent) without the considering the amount of the additive that is present, and if an additive “B” is present at a level 5 atomic percent “of the amount of silver present”; then the relationship between Ag, X, and B is found by subtracting 5 atomic percent from the atomic percent of silver, or the relationship between Ag, X, and B is Ag_{0.80} X_{0.15} B_{0.05} (respectively 80 a/o percent silver, 15 a/o percent “X”, and 5 a/o percent “B”).

As will be apparent to those of ordinary skill in the art the transparent conductive silver alloy thin films, including film stacks comprising silver alloy thin film of this invention and other materials have wide utility in a wide variety of devices. The following embodiments and examples are included for illustrative purposes only and should not be regarded as limiting this invention in any manner.

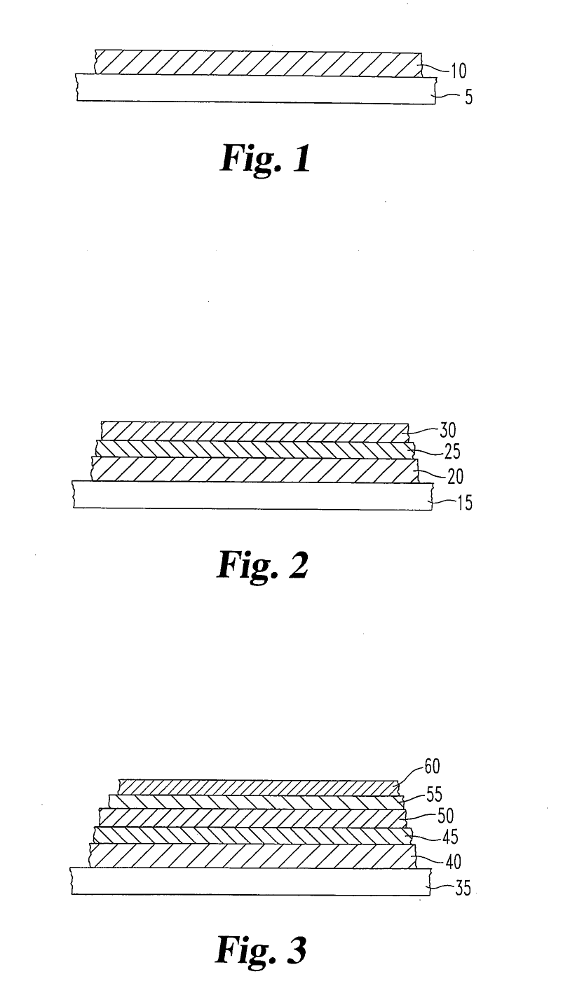

In one embodiment of this invention, the silver alloy layer is very thin yet continuous and coherent with the substrate, its transparency in the visible spectrum is quite high, typically greater than 60 percent. Silver alloys have inherently very high electrical conductivity, so long as the silver alloy is continuous it has a high electrical conductivity. Thus, very thin silver alloy layer will be very transparent, yet electrically conductive. Referring now to FIG. 1, silver alloy thin film 10 with a thickness of about 3 to 20 nanometers (nm) is deposited on transparent substrate 5 comprised of materials such as glass, PMMA, PET, or polycarbonate, or the like. A typical method for depositing this thin film transparent conductor is by thermal evaporation in a vacuum or by DC magnetron sputtering in argon atmosphere with a partial pressure in the range of 1 to 5 mili-torrs. In one embodiment of this invention, silver is alloyed with various elements such as gold, palladium, platinum, tin, zinc, silicon, cadmium, titanium, lithium, nickel, Indium, chromium, antimony, gallium, boron, molybdenum, germanium, zirconium, beryllium, aluminum, magnesium, manganese, and copper.

Table I lists the optical transmission (% T) at two wavelengths, 650 nm and 450 nm for various binary silver alloys layers with a thickness of about 5 nm. The concentrations of alloying elements are given in atomic percent. Table I also lists reflectivity (% R) of the silver alloys' when the silver alloy layer is at about 80 nm thick at two wavelengths 650 nm and 450 nm. In one preferred embodiment of this invention the amount of alloying element added to silver ranges from about 0.1 a/o percent to about 10.0 a/o percent, more preferably from about 0.2 a/o percent to about 5.0 percent, and most preferably from 0.3 a/o percent to about 3.0 a/o percent. In one preferred embodiment of the invention, silver is alloyed with copper present at about 0.01 atomic (a/o) percent to about 10.0 a/o percent.

In another embodiment of the invention, silver copper alloys with copper present from about 0.01 atomic (a/o) percent to about 10.0 a/o percent, are further alloyed with Au, Pd or Pt present in the range of about 0.01 a/o percent to about 10.0 a/o percent of silver, preferably in the range of 0.1 a/o percent to about 5.0 a/o percent.

In still another embodiment of the invention, silver copper alloys are further alloyed with elements such as: Sn, Zn, Si, Cd, Ti, Li, Ni, Co, Cr, In, Cr, Sb, Ga, B, Mo, Ge, Zr, Be, Al, Mg, and Mn. These third alloying element are present in the alloy in the amount ranging from about 0.01 a/o percent to about 10.0 a/o percent, preferably in the amount of about 0.1 a/o percent to about 5.0 a/o percent.

TABLE I

| | % T @ | % T @ | % R @ | % R @ |
|---|---|---|---|---|
| | 650 nm | 450 nm | 650 nm | 450 nm |
| Ag—1.0% Sn | 0.748 | 0.845 | 0.92 | 0.90 |
| Ag—2.5% In | 0.750 | 0.849 | 0.91 | 0.89 |
| Ag—0.4% Ti | 0.745 | 0.843 | 0.88 | 0.85 |
| Ag—10.3% Cd | 0.745 | 0.830 | 0.91 | 0.88 |
| Ag—0.8% Cu | 0.795 | 0.870 | 0.97 | 0.96 |
| Ag—0.8% Mo | 0.758 | 0.858 | 0.92 | 0.90 |
| Ag—1.5% Mn | 0.770 | 0.870 | 0.94 | 0.93 |
| Ag—11.0% Li | 0.765 | 0.854 | 0.93 | 0.90 |
| Ag—0.5% Pt | 0.760 | 0.867 | 0.96 | 0.95 |
| Ag—1.0% Zr | 0.780 | 0.870 | 0.93 | 0.90 |
| Ag—1.5% Al | 0.795 | 0.872 | 0.93 | 0.91 |
| Ag—1.5% Si | 0.745 | 0.860 | 0.90 | 0.87 |
| Ag—4.0% Zn | 0.765 | 0.851 | 0.93 | 0.91 |
| Ag—1.2% Pd | 0.780 | 0.875 | 0.96 | 0.95 |

Table II lists values of percent reflectivity (% R) and optical transmission (% T) for various ternary silver alloys of this invention, similar to the measurements listed in Table I for binary silver alloys.

TABLE II

| | % T @ | % T @ | % R @ | % R @ |
|---|---|---|---|---|
| | 650 nm | 450 nm | 650 nm | 450 nm |
| Ag—1.2% Pd—1.4% Zn | 0.77 | 0.86 | 0.95 | 0.93 |
| Ag—0.8% Cu—1.5% Mn | 0.763 | 0.855 | 0.94 | 0.92 |
| Ag—1.5% Al—1.0% Mn | 0.75 | 0.85 | 0.91 | 0.88 |
| Ag—1.0% Cu—0.3% Ti | 0.748 | 0.848 | 0.90 | 0.89 |
| Ag—1.2% Al—1.3% Zn | 0.76 | 0.859 | 0.93 | 0.92 |
| Ag—1.0% Ge—0.7% Al | 0.74 | 0.84 | 0.89 | 0.85 |
| Ag—1.2% Sb—0.3% Li | 0.733 | 0.83 | 0.83 | 0.80 |

In another embodiment of the present invention, a silver alloy thin film sandwiched by layers of ITO is attached to a substrate. Referring now to FIG. 2, transparent conductive oxide layer 20 is deposited by a vacuum coating process onto transparent substrate 15 comprised of materials such as glass, PMMA, PET, and polycarbonate, and the like, a thin film silver alloy 25 with a thickness ranging from about 5 nm to about 15 nm is deposited by another vacuum coating process, preferably a DC magnetron sputtering process, on top of layer 20, and another transparent conductive oxide layer 30, such as indium tin oxide or indium zinc oxide, is deposited on silver alloy thin film 25.

The film stack, as illustrated in FIG. 2, constitutes a transparent conductive stack that offers more environmental stability than the film structure illustrated in FIG. 1. The preferred silver alloy compositions of the silver alloy ITO film stack illustrated in FIG. 2 are basically the same as the compositions of the silver alloys disclosed in connection with FIG. 1. For example, in one preferred embodiment of this invention the amount of alloying element added to silver ranges from about 0.1 a/o percent to about 10.0 a/o percent, more preferably from about 0.2 a/o percent to about 5.0 percent, and most preferably from 0.3 a/o percent to about 3.0 a/o percent. In one preferred embodiment of the invention, silver is alloyed with copper present at about 0.01 atomic (a/o) percent to about 10.0 a/o percent.

In another embodiment of the invention, silver copper alloys with copper present from about 0.01 atomic (a/o) percent to about 10.0 a/o percent, are further alloyed with Au, Pd or Pt present in the range of about 0.01 a/o percent to about 10.0 a/o percent of silver, preferably in the range of 0.1 a/o percent to about 5.0 a/o percent.

In still another embodiment of the invention, silver copper alloys are further alloyed with elements such as: Sn, Zn, Si, Cd, Ti, Li, Ni, Co, Cr, In, Cr, Sb, Ga, B, Mo, Ge, Zr, Be, Al, Mg, and Mn. These third alloying element are present in the alloy in the amount ranging from about 0.01 a/o percent to about 10.0 a/o percent, preferably in the amount of about 0.1 a/o percent to about 5.0 a/o percent in Tables I and II.

In another embodiment of the current invention, the silver alloy thin film can be sandwiched by a dielectric layer or a high refractive index layer such as tin oxide, indium oxide, bismuth oxide, titanium oxide, zinc oxide, aluminum oxide, zinc sulfide, etc. and mixed oxides thereof. Referring now to FIG. 2, any of the silver alloy thin film compositions of this invention can be applied at a thickness in the range of 3 to 20 nm to form a film 25; and sandwiched by dielectric layers 20 and 30 or high refractive index layers 20 and 30 or mixtures thereof. Combinations thereof can be used in a number of applications such as in the construction of an energy efficient window.

The percent light transmission (% T) values in the visible spectrum for the silver alloys useful in this embodiment are similar to the values listed for the silver alloys in TABLE I and TABLE II. However, the % reflectivity (% R) for light at wavelengths 700 nm to 3 microns in the infrared will be higher than the % reflectivity values listed for the silver alloys in TABLES I and II. Thus, about half or more of the infrared radiation impinging on the stack be reflected back towards the source of the radiation. The % of light in the visible range transmitted and the % of radiation in the infrared and near infrared range reflected, can be maximized by properly selecting: the dielectric material, the silver alloy thin film, and their thickness. This embodiment of this invention can be used, for example, to create energy efficient windows.

In still another embodiment of the invention, a plurality of transparent oxide, and silver alloy thin films of the invention, are layered upon one another such that the silver alloy thin films are between layers of transparent oxide. Referring now to FIG. 3, 35 is a transparent substrate, 45 and 55 are the silver alloy thin film of this invention and 40, 50 and 60 are conventional transparent oxide conductor such as ITO and the like. The silver alloy thin films of this embodiment can have the same or similar compositions as the silver alloy thin films listed in TABLES I and II, and used in embodiments illustrated in FIGS. 1 and 2. For example, in one preferred embodiment of this invention the amount of alloying element added to silver ranges from about 0.1 a/o percent to about 10.0 a/o percent, more preferably from about 0.2 a/o percent to about 5.0 percent, and most preferably from 0.3 a/o percent to about 3.0 a/o percent. In one preferred embodiment of the invention, silver is alloyed with copper present at about 0.01 atomic (a/o) percent to about 10.0 a/o percent.

In another embodiment of the invention, silver copper alloys with copper present from about 0.01 atomic (a/o) percent to about 10.0 a/o percent, are further alloyed with Au, Pd or Pt present in the range of about 0.01 a/o percent to about 10.0 a/o percent of silver, preferably in the range of 0.1 a/o percent to about 5.0 a/o percent.

In still another embodiment of the invention, silver copper alloys are further alloyed with elements such as: Sn, Zn, Si, Cd, Ti, Li, Ni, Co, Cr, In, Cr, Sb, Ga, B, Mo, Ge, Zr, Be, Al, Mg, and Mn. These third alloying element are present in the alloy in the amount ranging from about 0.01 a/o percent to about 10.0 a/o percent, preferably in the amount of about 0.1 a/o percent to about 5.0 a/o percent.

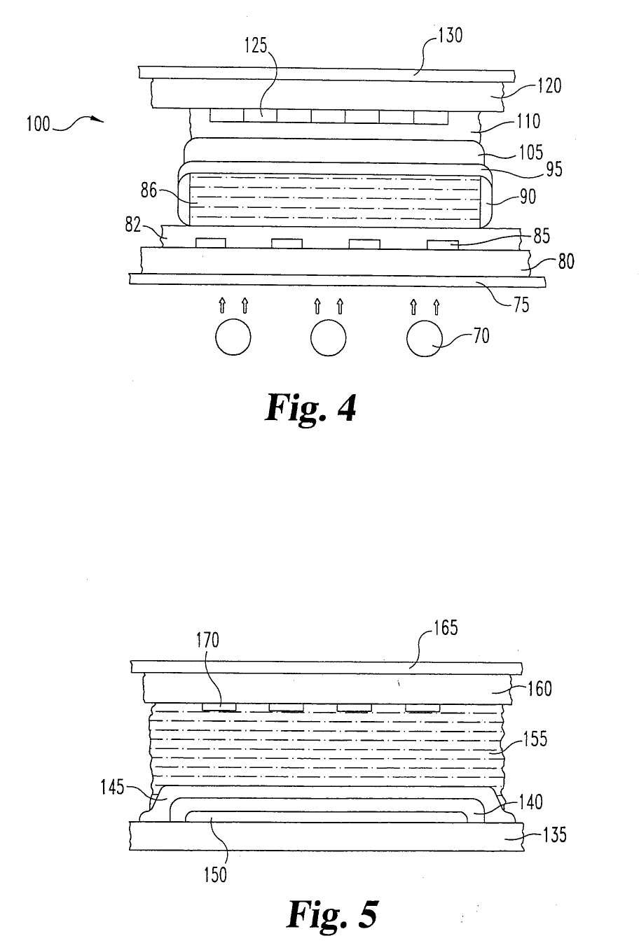

In another embodiment of this invention, silver alloy thin films are used in the construction of liquid crystal display (LCD) devices. Referring now to FIG. 4, LCD 100, comprises polarizers 130 and 75 attached to transparent substrates 80 and 120, a light source 70 is adjacent to polarizer 75, a transparent conductor 85 is deposited on the side of substrate 80 opposite that of polarizer 75, a liquid crystal alignment layer 82 is on top of the transparent conductor 85; a liquid crystal seal 90 surrounds liquid crystal 86, and is adjacent to liquid crystal alignment layer 82; a second liquid crystal alignment layer 95 is located on top of the liquid crystal seal and is adjacent to a second transparent conductor layer 105; a passivatioin layer 110 is on top of transparent conductor 105 and adjacent to color elements on substrate 120. Transparent conductive layers 85, and 105 are silver alloys of the invention. When energized the light source 70 emits visible light which passes through the whole device from polarizer 75 though polarizer 130. In 85 and 105 of FIG. 4, a silver alloy thin film of the current invention as disclosed for FIG. 1 and FIG. 2 can be used.

For a detailed description of the operation of a LCD, one can refer to U.S. Pat. Nos. 6,122,027, 6,040,056, 6,087,680 or 6,014,196, which are hereby incorporated by reference.

In yet another embodiment of the invention, the silver alloy compositions disclosed herein can be used in a reflective type liquid crystal display as illustrated in FIG. 5, 135 is a substrate, 150 is a silver alloy reflector of the current invention, 140 an electrically insulating layer, 145 an electrically conducting conductor such as ITO or a thin silver alloy film 3 to 20 nm in thickness of the current invention, 155 a liquid crystal, 170 a transparent conductor such as ITO, 160 a transparent substrate, and 165 is a polarizer. To provide high reflectivity in the visible range the silver alloy reflective layer has a thickness in the range of 40 to 200 nm, and preferably in the range of 50 to 100 nm. The silver alloy composition mentioned in FIG. 1 or FIG. 2 can be used here for the silver alloy reflector 150 or silver alloy transparent conductor 145. For a detailed description of reflective LCD technology one can refer to U.S. Pat. No. 6,081,310, which is hereby incorporated by reference.

In another embodiment of the invention, the thin film silver alloy layers of the current invention are used as a transparent conductor and as an anode in an organic light emitting diode (OLED). In an OLED, an electric voltage is applied to a semi-conducting polymer to generate visible light. This phenomenon is referred to as the electroluminescence effect. Recent developments in OLED technology have demonstrated that organic electroluminescence is a viable display option in a variety of applications. The light emitting polymer can be a small molecule with molecular weight in the range of several hundred or a large molecule, such as polyphenylene vinylene, with a molecular weight ranging from ten thousand to several millions. OLEDs that use polyphenylene vinylene are sometimes referred to as PLEDs.

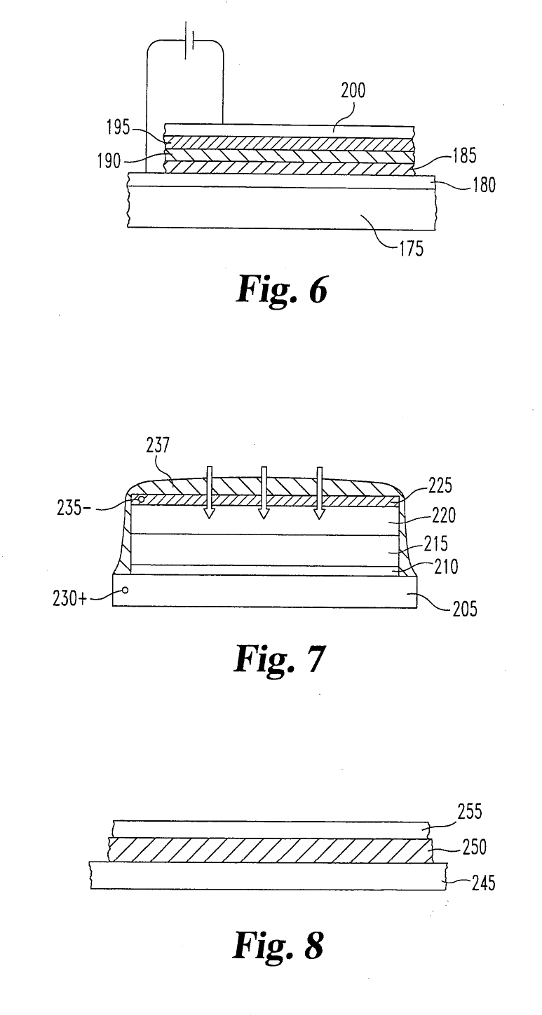

Referring now to FIG. 6. A conventional OLED comprises a transparent substrate 175 such as glass or plastic, on a transparent conductor 180 such as a coating of indium-tin-oxide (ITO) applied by a sputtering technique, and a light emitting polymer 190 added by vacuum evaporation for small molecule type devices or by spin coating for large molecule type devices. To improve device efficiency, the light emitting polymer 190 is normally sandwiched by hole conductor 185 and electron conductor 195. On top of electron conductor 195, there is metallic cathode 200. When an electrical voltage is applied to the device the organic polymer 190 emits light.

Although ITO has been used as the transparent conductor material in OLED for years, it suffers from at least three drawbacks. One, the ITO layer needs to be from 100 to 150 nm or more thick, in order to provide sufficient electrical conductivity. Two, ITO has a very low sputter rate (common to oxides) and therefore it takes in the range of several minutes to an hour to deposit a layer of ITO with sufficient thickness to function properly in these applications. The ITO surface formed, at the thickness required for proper function, is relatively rough, which leads to electrical shorts decreasing device lifetimes and reducing the yield of useful devices. Three, with a deposition temperature on the order of 200 degrees C., ITO cannot be applied to a number of transparent plastic substrates, as they cannot withstand the temperatures required to deposit ITO. This severely limits the use of ITO in devices with mechanically flexible displays.

The silver alloy thin films of this invention are an excellent replacement for ITO in OLED and PLED applications. When deposited at a thickness in the range of 4 to 15 nm, the silver alloys of this invention are functional in OLED and PLED applications and are 10 to 25 times thinner than ITO. The silver alloys of this invention when used in OLED and PLED applications can be deposited at a rate 10 to 100 times faster than the deposition rate of ITO. Additionally, the silver alloy thin films of this invention can be formed on many transparent plastic substrates suitable for use applications such as OLEDs and PLEDs.

In one embodiment of the invention, silver alloyed with suitable alloying elements such as Cu, Pd, Pt, Au, Zn, Si, Cd, Sn, Li, Ni, In, Cr, Sb, Ga, B, Mo, Ge, Zr, Be, Al, Mn, Mg, Co, and Ti added separately or in combination with one another and present in the range of about 0.01 atomic percent to about 10.0 atomic percent, are suitable for use as transparent anodes in display devices. Alternatively, the structures illustrated in FIG. 1, 2 or 3 can be used to construct the unit illustrated in FIG. 6. Referring now to FIG. 6 a silver alloy thin film is deposited as a coherent and continuous layer 180 on transparent substrate 175. The transparent anode 180 is a silver alloy thin film with a thickness of about 5 nm, used for example, with an ITO layer with a thickness of about 30 nm which is then covered by hole conductor 185; hole conductor 185 is covered by light emitting polymer 190. In some OLED or PLED applications, patterning of the silver alloy transparent conductor is required, or desirous, and can be done through a photolithography process followed by a wet-etching process using a suitable etching agent such as, for example, a nitric acid solution. Alternatively, patterning can be done by applying a suitable light emitting polymer 190 by ink-jet printing instead of by spin coating.

In yet another embodiment of this invention, silver alloy thin film compositions described for use in OLED and PLED applications are used as a transparent conductor in a solar cell. Referring now to FIG. 7 a p-n junction is formed at the interface of p type semiconductor 215 and n type semiconductor 220. On one side of the n-p pair is transparent conductor 225 on the opposite side of the n-p pair is ohmic contact 210. Ohmic conductor 210 is also attached to metallic substrate 205. Metallic substrate 205 is commonly rigid and formed from materials such as stainless steel; conductive metal electrode 210 is commonly made of material such as aluminum, typically applied to the metallic substrate 205 by sputtering. The whole device may be encapsulated in a transparent coating 237, commonly an UV cured resin, epoxy, or the like, to provide a weather resistance surface suitable for outdoor use.

In normal operation, sunlight passes through transparent coating 237 and transparent conductor silver alloy thin film 225 and reaches the p-n junction to generate electron and hole pairs. The electrons move to the upper side causing it to become negatively charged and the holes moves to the lower side causing it to become positively charges. Thus, sunlight creates an electromotive force (a voltage gradient) across the device. A silver alloy thin film with a thickness range of about 4 to about 20 nm is used as transparent conductor 225, it allows sunlight to reach the electricity generating layer. The corrosion resistance of the silver alloy thin film 225 can be further enhanced by providing a layer of ITO with a thickness of about 10 to 20 nm or more, between the transparent conductor 225 and transparent polymer 237.

In another embodiment of the invention, a stack for high light transmission is constructed comprising a silver alloy thin film, deposited on a substrate, and covered by an organic or inorganic layer. The organic or inorganic coatings provide additional corrosion resistance to the stack. Suitable silver alloys for practice of this invention include any of the silver alloys of the present invention with desirous, light transmission properties. Organic coatings suitable for the practice of the invention include, acrylic based UV resins, epoxies, epoxides, or the like. Inorganic materials, suitable for practice with the invention, include dielectric materials, metal oxides, or oxides such as silicon oxide, titanium oxide, indium oxide, zinc oxide, tin oxide, aluminum oxide etc. mixture of such oxide and nitride or carbide such as silicon nitride, aluminum nitride, silicon carbide etc. and mixtures of such oxide, nitride, carbide and mixtures thereof.

Referring now to FIG. 8 in applications where only the optical transparency requirement is necessary or desirous, the selection requirement of coating 255 is optical transparency. If transparent substrate 245 is a flexible substrate such as a polyester film or the like, a moisture barrier layer of a metal oxide, nitride or carbide as mentioned above may be incorporated into the film stack between substrate 245 and silver alloy thin film 250. If the film stack is used as a transparent conductor, then coating 255 on top of the silver alloy thin film 250 could be a transparent conducting oxide such as ITO, indium oxide, tin oxide, zinc oxide, other metal oxides and mixtures thereof.

In still another embodiment of this invention, the film stack may resemble the configuration of those illustrated in FIG. 2 or 3 wherein the silver alloy thin film 25, 45 or 55 of the current invention may be sandwiched by ITO, and other electrically conducting metal oxides.

### EXAMPLE 1

The process of making a stack for use in a transmission type liquid crystal display comprising silver alloys of the invention is as follows. A glass substrate was prepared by thoroughly cleaning and rinsing it. As illustrated in FIG. 2 successive layers of ITO 20, silver alloy 25, and ITO 30 having thickness 40, 10 and 80 nm respectively were deposited by sputtered in a DC magnetron sputtering apparatus to form a transparent conductor stack on glass substrate 15. The silver alloy sputtering target used in this example was comprised of silver, 2.0 a/o % Zn, and 1.2 a/o Al. Next, a sputtering photolithography process was used to deposit a photoresist, and a specific pattern was developed by etching the surface using a solution comprising hydrochloric acid. The result of the etching was a conductor pattern with a width of 40 microns and space between conductors of 20 microns. This patterned transparent conductor can be used, for example, to form part of liquid crystal display assembly.

### EXAMPLE 2

The process of making a reflective type liquid crystal display comprising silver alloy thin films of this invention is described. Referring now to FIG. 5. A DC magnetron sputtering device and a silver alloy sputtering target comprising silver, 1.0 a/o Cu and 0.3 a/o % Ti is used to deposit a silver alloy thin film 150 with a thickness of about 60 to 80 nm on transparent glass substrate 135. The silver alloy thin film deposited on the transparent glass substrate acted as a reflective film. An electrically insulating layer or organic material layer 140 is formed on reflective film 150, a layer of ITO 145 is deposited on layer 140 using a sputtering process. A layer of ITO 170 is deposited on substrate 160 and can be etched to form an electrode pattern. A layer of liquid crystal 155 is sandwiched between ITO layers, 140 and 170 forming an element of a display unit.

### EXAMPLE 3

A test of the corrosion resistance of a stack comprising a silver alloy thin film of this invention was carried out. Referring now to FIG. 3, silver alloy thin film 40, comprising aluminum 0.6 wt. %, copper 1.0 wt. % and silver 98.4 wt. % was deposited by a DC sputtering process to a thickness of about 50 nm, on substrate 35, next a n-type semiconductor 45 with a thickness of 50 nm was deposited on layer 40, then a p-type semiconductor 50 with a thickness of about 50 nm was deposited on n-type semiconductor 45, then a silver alloy thin film 55 with a thickness of about 6 nm comprising palladium 1.0 wt. %, copper 1.0 wt. % and silver 98.0 wt. % was deposited by a DC sputtering process on p-type semiconductor 50; and finally the entire assembly was spray coated with a clear organic coating 60, and UV cured to form a weather tight layered stack suitable for outdoor use. The stability of the stack was tested in an accelerated aging test wherein the device was held at 80 degrees C., 85% Relative Humidity (RH) for 10 days. Over this time period no significant degradation of the device's performance was observed.

### EXAMPLE 4

A test of a silver alloy thin film of this invention in the construction of an energy efficient window coating is conducted. A plastic film such as polyethylene terephthalates (PET) is used as a transparent substrate. Successive films of indium oxide about 50 nm thick, a silver alloy thin film about 6 nm thick, and a layer of indium oxide about 50 nm thick are deposited on a substrate by sputtering. The indium oxide film is formed using a reactive ion sputtering process and a pure indium target. The silver alloy thin film is deposited by a DC magnetron sputtering process using a sputtering target comprising silver, copper 1.0 a/o percent, and titanium 0.2 a/o percent. The film stack has an overall light transmission in the range of 70 to 80% in the visible spectrum and reflects more than 50% of infrared radiation with a wavelength greater than 1.5 microns. The stability of the film stack is tested in an accelerated aging test, the stack is held at 70 degrees C., and 50% Relative Humidity (RH) for 4 days, over this time period there is no significant degradation of the stack's performance.

### EXAMPLE 5

A silver alloy thin film of this invention is used as a transparent conductor in a polymer light emitting diode (PLED). A structured layer of silver alloy thin film about 6 nm in thick is deposited using a DC sputtering process on a glass substrate. The composition of the silver alloy target for use in the sputtering process is about 1.0 a/o percent zinc, about 0.5 a/o percent aluminum, and about 98.5 a/o percent silver. A hole-conducting polymer p-type semiconductor, polyanyline at a thickness of about 100 nm is deposited on the silver thin film from an aqueous solution. A light emitting polymer, ployphenylene vinylene in an organic solvent, is applied to the stack by either spin-coating or ink-jet-printing. A low work function metal such as calcium at a thickness of about of about 5 nm, and aluminum at a thickness of about 70 nm are applied by thermal evaporation forming the cathode. The silver alloy thin film functions as an anode in the device. When a voltage is applied to the device, electrons are injected from the cathode into the light emitting polymer and holes are injected from the anode into the hole-conductor and, then into the light emitting polymer. The electrons and the holes combine, in the light emitting polymer, forming an exciton that decays to the ground state emitting stable light in the process.

While the invention has been illustrated and described in detail, this is to be considered as illustrative and not restrictive of the patent rights. The reader should understand that only the preferred embodiments have been presented and all changes and modifications that come within the spirit of the inventions are included if the following claims or the legal equivalent of these claims describes them.

1. A display device, comprising:
a first substrate including an array of pixel electrodes;
a second substrate including a counter electrode; and
an organic fluid layer interposed between said first and said second substrates, wherein said first substrate contains a highly reflective layer, said highly reflective layer is a metal alloy comprising:
silver; and
a second element present in the range of from 0.1 to 10.0 a/o percent selected from the group of elements: copper, manganese, magnesium, beryllium, zinc, cadmium, lithium, zirconium, silicon, aluminum, indium, titanium, nickel, chromium, cobalt, antimony, gallium, boron, tin, molybdenum and germanium.

2. A display device according to claim 1, wherein the said metal alloy comprises:
silver;
copper in the range 0.1 to 5.0 a/o percent; and
a third element present in the range of 0.1 to 5.0 a/o percent selected from the group: zirconium, cadmium, lithium, zinc, silicon, germanium, aluminum, titanium, indium, tin, beryllium, manganese, nickel, chromium, cobalt, antimony, gallium molybdenum, bron and magnesium.

3. A display device according to claim 1, wherein said display unit is a reflective type liquid crystal display.

4. A window coating, comprising:
a transparent substrate; and
a film stack comprising:
a thin film of silver alloy comprising:
silver; and
a second element in the range of 0.1 a/o percent to 10.0 a/o percent selected from the group: gold, palladium, platinum, copper, zinc, cadmium, aluminum, titanium, lithium, magnesium, manganese, silicon, germanium, beryllium, tin, indium, nickel, cobalt, chromium, antimony, gallium, boron, molybdenum and zirconium.

5. A window coating according to claim 4, comprising:
said thin film silver alloy;
a dielectric layer; and
an oxide layer wherein said thin film silver alloy is between said dielectric layer and said oxide layer.

6. A display device according to claim 2, wherein said display unit is a reflective type liquid crystal display.
